(19) United States
(12) Patent Application Publication
(10) Pub. No.: US 2001/0038888 A1
(43) Pub. Date: Nov. 8, 2001

(54) Pressure-saturating system for moving web

(75) Inventors: Ernst Klas, Siegburg (DE); Gisbert Krossa, Wulfrath (DE); Walter Muller, Reichshof (DE); Udo Unger, Leichlingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: VITS MASCHINENBAU GmbH

(21) Appl. No.: 09/745,203

(22) Filed: Dec. 21, 2000

(30) Foreign Application Priority Data
Dec. 24, 1999 (DE) 19963151.4

(51) Int. Cl. B05D 3/04; B05D 3/12

(52) U.S. Cl. 427/385.5; 427/348; 427/369

(57) ABSTRACT

A system for treating a porous web with a liquid treatment liquid continuously moves the web along a path sequentially through a saturating station, steaming station, and drying station. A drum in the saturating station engages a back face of the web and a trough closely surrounds the drum and confronts a front face of the web. Seals form between the drum and trough a generally closed and pressurizable chamber through which the web passes and which is supplied with the treatment liquid at superatmospheric pressure so as to force the liquid against only the front face of the web. In the steaming station jets of steam are directed against the back face of the web to heat the web and disperse the treatment liquid throughout the web. The web is heated and dried in the drying station.

### FIELD OF THE INVENTION

The present invention relates to a pressure-saturating system. More particularly this invention concerns impregnating a moving web with a liquid.

### BACKGROUND OF THE INVENTION

It is known to saturate a web substrate, e.g. kraft paper, with a liquid such as a phenolic-resin or an alkali-metal-sulfate solution, to impart increased stiffness, fire-resistance, or other properties to it. A standard way of doing this as described in U.S. Pat. Nos. 4,411,216, 4,588,616, and 4,915,989 of Menser, German utility models 295 01 918 and 295 01 919 of Vits, and SU 1,080,109 of Peglovski is by passing the web through about 180° around a drum whose lower portion is held in a trough filled with the treatment solution. The drum is typically not smooth, but instead has a highly textured or profiled surface so air cannot be trapped between it and the back face of the web work-piece engaging it. Seals may be provided between the trough on the outside and the web-wrapped drum on the inside so that the liquid in the trough can be under pressure and will, therefore, be forced into and even through the web.

The web exits this soaking stage fairly saturated with the solution and is then typically pulled through a tunnel-type dryer such as described in German patent 3,000,385 of Vits to drive out the solvent and leave the fibers of the work-piece coated with the active ingredient in the saturating solution. Application of the solution to the web with a pressure differential ensures that even a relatively thick solution, that is one with a low solvent content, can be forced substantially all the way through even a relatively dense web without actually wetting the back face, making subsequent handling of the web much easier. An amount of material can be forced into the paper to almost double its mass.

Practice has shown that with a trough-type saturator using a pressure differential it is possible to impregnate a paper web with a phenolic-resin solution containing only half as much solvent as would be necessary in an unpressurized dip-type saturator, while moving the web at twice the speed as in a conventional system. An end content of 38% to 45% by weight of the resin in the paper is achieved to produce a very strong and stiff end product.

Kraft paper having a resin content of 36° to 37° is used for making countertops or floor coverings. Such a relatively low resin content can easily be achieved with the known pressure-saturating systems. The pressure can be adjusted to achieve a wide range of saturation levels.

Practice has shown however that when the pressure-type saturators are used at well below their maximum capacity, the web is not saturated uniformly, but the treatment liquid is primaril on the side of the web toward the front face thereof which is exposed in the treatment chamber. The front face that is turned outward as the web passes through the trough is thoroughly exposed to the solution and thoroughly saturated, but the solution does not often get through to the back face of the web.

If not fully saturated, there can be subsequent problems with bubbling or nonadherence, resulting in a nonplanar product. This problem can be solved by increasing the resin content, but the resultant product can be too stiff and is expensive and difficult to produce. Not saturating the web through to its back face has the huge advantage that this back face stays dry and the web is easier to handle, without buildup of the saturating solution on the various drive rollers. Furthermore the roller around which the web is wrapped stays dry and does not have to be cleaned periodically to prevent its grooves and surface profiling from filling up.

Above-cited German patent 3,000,385 soaks the web in an ambient-pressure system simply by applying the solution to the front face of the web. Then the front face is cooled while the rear face is heated with saturated steam to draw the solution down through the web. The resultant product is often unsatisfactory as the treatment material forms at best spots on the back face of the web while it pools to form a film on the front face. Thus this system cannot work well to produce a web that is not heavily saturated.

### OBJECTS OF THE INVENTION

It is therefore an object of the present invention to provide an improved web-impregnating system and method.

Another object is the provision of such an improved web-saturating system which overcomes the above-given disadvantages, that is which produces a web that is evenly soaked with the treatment liquid even at low overall content levels of the liquid in the web.

### SUMMARY OF THE INVENTION

A system for treating a porous web with a liquid treatment liquid according to the invention continuously moves in a path sequentially through a saturating station, steaming station, and drying station. A drum in the saturating station engages a back face of the web and a trough closely surrounds the drum and confronts a front face of the web. Seals form between the drum and trough a generally closed and pressurizable chamber through which the web passes and which is supplied with the treatment liquid at superatmospheric pressure so as to force the liquid against only the front face of the web. In the steaming station jets of steam are directed against the back face of the web to heat the web and disperse the treatment liquid throughout the web. The web is heated and dried in the drying station.

This arrangement produces a system where even though the web is not as thoroughly saturated as the equipemnt would in theory allow, the treatment liquid is dispersed uiformly throughout the web, from surface to surface. The application of steam to the front face heats the web to increase its wicking capacity and draw the liquid all the way into and through it.

Means is provided according to the invention between the saturating station and the steaming station for removing excess treatment liquid from the front face of the web. At most 20 g/m² of the liquid is left on the front face of the web, a tiny amount. The removing means can be a scraper or a roller engaging the front face of the web.

The chamber is pressurized at at least 0.1 bar. Furthermore the web lies substantially in a horizontal plane with the front face directed upward as it passes through the steaming and drying stations.

### BRIEF DESCRIPTION OF THE DRAWING

The above and other objects, features, and advantages will become more readily apparent from the following description, reference being made to the accompanying drawing in which:

FIG. 1 is a largely schematic view of the system of this invention;

FIG. 1A is a large-scale view of a detail of FIG. 1;

FIG. 2 is a detail view on an alternative system in accordance with the invention.

### SPECIFIC DESCRIPTION

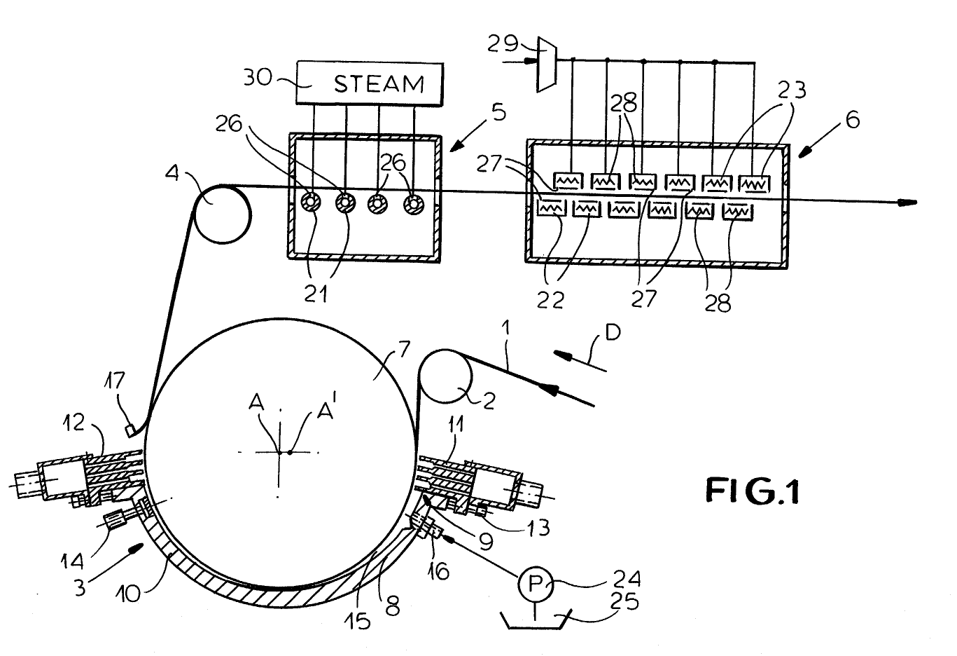

As seen in FIG. 1 a web 1, here of kraft paper, is moved in a transport direction D over an input deflecting roller 2 and through a pressure-type saturating apparatus 3. Thence the web 1 passes over an output deflecting roller 4, through a steamer 5, and through a dryer 6.

As described in above-cited German utility model 295 01 918, the saturating apparatus comprises a cylindrical drum 7 having an outer face formed with square-section truncated pyramidal bumps 31 (FIG. 1A) that bear against a back face of the web 1 which passes around slightly more than 180° of the drum 7 relative to its central rotation axis. A semicylindrical trough 8 surrounds the lower half of the drum 7 to form therewith an arcuate chamber 15. The trough 8 has an axis A′ offset slightly upstream relative to the travel direction D to the axis A so that the chamber 15 is of decreasing radial dimension from its input end 9 to its output end 10.

Seals 11 and 12 at the ends 9 and 10 have multiple lips and are pumped out, and the unillustrated flat ends of the drum 7 fit snugly against flat end panels of the trough 8 so that the chamber 15 is effectively closed and, therefore, pressurizable. Respective tighteners 13 and 14 ensure that the seals 11 and 12 bear tightly against the front face of the web 1 wrapped around the drum 7. A nozzle 16 connected to a pump 24 receiving a phenolic-resin/methanol solution from a supply 25 pressurizes the chamber 15 at a superatmospheric pressure of at least 0.1 bar, here 0.5 bar to 2.5 bar.

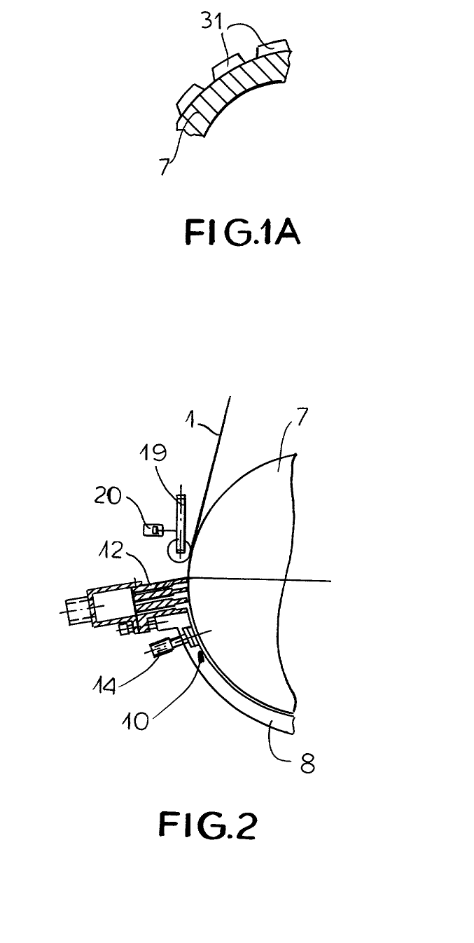

After the web 1 emerges from the outlet end 10 of the chamber 15, its front face is doctored clean by a scraper 17 some 20° offset from the outlet 10. This reduces its surface coating to about 5 g/m². Alternately as shown in FIG. 2 a roller 18 carried on a pivotal lever 19 urged toward the drum 7 serves to clean off the front web face, leaving a somewhat heavier but still quite thin surface coating of 10 g/m² to 20 g/m². The roller 18 has the advantage that fibers from the web 1 do not build up on it.

Subsequently the web 1, about 36%-37% of whose weight is constituted by the solution absorbed in the saturator 3, goes in a straight line through the steamer 5 and then through the dryer 6. In the steamer an array of four nozzle pipes 21 having upwardly open outlet nozzles or openings 26 are connected to a source 30 of steam at superatmospheric pressure. The back face of the web 1 is essentially dry and free of any of the liquid applied in the saturator 3. The steam applied from the nozzles 26 is only under slight pressure which is set such relative to the temperature of the steam that it lies only slightly above the condensation point. Thus the steam will condense on the back face of the web 1 and will thereby heat it substantially. This improves the capacity of the paper to absorb the treatment liquid which will therefore disperse and uniformly distribute itself throughout the web 1.

In the dryer 6 air fed in from a blower 29 is supplied to a plurality of lower and upper heater boxes 22 and 23 each provided with a heater element 28 and formed with two nozzle slits 27 or rows of holes so as to blow hot air on the now uniformly soaked web 1 and drive out the methanol acting as solvent. This leaves the fibers of the paper of the web 1 coated in phenol, making the web 1 very stiff.

We claim:

1. A system for treating a porous web with a liquid treatment liquid, the system comprising:
means for passing the web continuously in a path sequentially through a saturating station, steaming station, and drying station;
a drum in the saturating station engaging a back face of the web;
a trough closely surrounding the drum and confronting a front face of the web;
seal means for forming between the drum and trough a generally closed and pressurizable chamber through which the web passes;
means for supplying the treatment liquid at superatmospheric pressure to the chamber and thereby forcing the liquid against only the front face of the web;
means in the steaming station for directing jets of steam against the back face of the web and thereby heating the web; and
means in the drying station for heating and drying the web.

2. The web-treatment system defined in claim 1, further comprising
means between the saturating station and the steaming station for removing excess treatment liquid from the front face of the web.

3. The web-treatment system defined in claim 2 wherein the means for removing leaves at most 20 g/m² of the liquid on the front face of the web.

4. The web-treatment system defined in claim 2 wherein the removing means is a scraper engaging the front face of the web.

5. The web-treatment system defined in claim 2 wherein the removing means is a doctor roller bearing against the front face of the web.

6. The web-treatment system defined in claim 1 wherein the means for supplying pressurizes the chamber at at least 0.1 bar.

7. The web-treatment system defined in claim 1 wherein the web lies substantially in a horizontal plane with the front face directed upward as it passes through the steaming and drying stations.

8. The web-treatment system defined in claim 1 wherein the steaming means applies to the front face of the web steam slightly above the condensation point, whereby the steam condenses on the front face of the web.

9. A method of treating a porous web with a liquid treatment liquid, method comprising the steps of:
passing the web continuously in a path sequentially through a saturating station, a steaming station, and a drying station;
looping the web in the saturating station around a rotatable drum with a back face of the web engaging the drum;
forming around the front face of the web at the drum a substantially closed chamber and filling the chamber with the treatment liquid under superatmospheric pressure to force the liquid against only the front face of the web and into the web;
directing jets of steam against the back face of the web in the steaming station and thereby heating the web; and
heating and drying the web in the drying station.

10. The web-treatment method defined in claim 9 wherein the liquid in the chamber is pressurized to at least 0.1 bar.

11. The web-treatment method defined in claim 9, further comprisign the step of
removing fron the front face of the web bewtween the saturating and steaming stations treatment liquid in excess of 20 g/m².
